(19) United States
(12) Patent Application Publication
(10) Pub. No.: US 2026/0135856 A1
(43) Pub. Date: May 14, 2026

(54) CREDENTIAL MESH NETWORK FOR MOBILE-BASED ACCESS CONTROL

(71) Applicant: Tyco Fire & Security GmbH, Neuhausen am Rheinfall (CH)

(72) Inventor: Saravana KUMAR, Bangalore (IN)

(21) Appl. No.: 19/390,243

(22) Filed: Nov. 14, 2025

Related U.S. Application Data
(60) Provisional application No. 63/720,491, filed on Nov. 14, 2024.

(51) Int. Cl. H04L 9/40

(52) U.S. Cl. CPC H04L 63/104; H04L 63/0807

(57) ABSTRACT

Some non-limiting example aspects of the present disclosure include methods, apparatuses, and computer-readable media comprising identifying, by a first access control mobile device, a personnel identifier (ID) associated with a card read by the first access control mobile device; determining whether personnel credential information associated with the personnel ID is available in the first access control mobile device; and displaying the personnel credential information responsive to the personnel credential information being available in the first access control mobile device.

### CROSS-REFERENCE TO RELATED APPLICATIONS

This application claims the benefit of U.S. Provisional Application No. 63/720,491, filed on Nov. 14, 2024 and entitled “CREDENTIAL MESH NETWORK FOR MOBILE-BASED ACCESS CONTROL,” the contents of which are incorporated by reference herein in the entirety.

### FIELD

The present disclosure relates generally to access control systems, and more specifically, to mobile-based access control systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method comprising receiving, by a server, a plurality of device identifier (ID) tokens from a plurality of access control mobile devices, wherein each device ID token uniquely identifies a corresponding access control mobile device, wherein the plurality of access control mobile devices comprises at least a first access control mobile device and a second access control mobile device. The method further comprises defining a group configured for forming a mesh network for sharing access credentials therebetween, wherein the group comprises at least the first access control mobile device and the second access control mobile device. The method further comprises assigning a group ID token to the group. The method further comprises transmitting, to the first access control mobile device and the second access control mobile device, a group command with the group ID token, wherein the group command is configured to inform the first access control mobile device and the second access control mobile device of creation of the group for forming the mesh network for sharing the access credentials therebetween.

Another example aspect includes a method comprising broadcasting, by a first access control mobile device uniquely identified by a first device identifier (ID) token, a first message comprising a group ID token identifying an access control mobile device group configured for forming a mesh network for sharing access credentials therebetween. The method further comprises receiving, by the first access control mobile device, from a second access control mobile device, a second message responsive to the first message, the second message indicating that the second access control mobile device is in the access control mobile device group, the second message including a second device ID token that uniquely identifies the second access control mobile device. The method further comprises transmitting, by the first access control mobile device, to the second access control mobile device, a third message comprising the first device ID token and an acknowledgment acknowledging the second message.

A further example aspect includes a method comprising identifying, by a first access control mobile device, a personnel identifier (ID) associated with a card read by the first access control mobile device. The method further includes determining whether personnel credential information associated with the personnel ID is available in the first access control mobile device. The method further includes displaying the personnel credential information responsive to the personnel credential information being available in the first access control mobile device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of an example mobile-based access control system, according to some aspects of the present disclosure;

FIG. 2 is an example flow diagram for credential mesh network creation, according to some aspects of the present disclosure;

FIG. 3 is an example flow diagram for an initial handshake in a credential mesh network, according to some aspects of the present disclosure;

FIG. 4 is a first example flow diagram of credential management in response to access credential activity, according to some aspects of the present disclosure;

FIG. 5 is a second example flow diagram of credential management in response to access credential activity, according to some aspects of the present disclosure;

FIG. 6 is a block diagram of an example computing device which may implement all or a portion of any component or functionality in FIGS. 1-5 and/or in FIGS. 7-9, according to some aspects of the present disclosure;

FIG. 7 is a flow diagram of an example method for creating a credential mesh network, according to some aspects of the present disclosure;

FIG. 8 is a flow diagram of an example method for an initial handshake in a credential mesh network, according to some aspects of the present disclosure; and

FIG. 9 is a flow diagram of an example method for checking credentials in a credential mesh network, according to some aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Aspects of the present disclosure provide a mobile-based access control system in which a number of access control mobile devices securely share credentials within a group, thus eliminating the need for uninterrupted access to a central management system/server. The access control mobile devices synchronize with each other even when offline (e.g., even when disconnected from the central management system/server) to ensure data availability for scenarios such as mustering and checkpoints. In an aspect, a mesh management service registers and groups the access control mobile devices into a mesh network, allowing automatic identification and secure data exchange. The access control mobile devices hold a catalog of available credentials, update the catalog dynamically, and download the catalog upon request or upon an access credential activity which may be any activity that elicits/requests confirmation of access credentials of an entity for access to an area/asset, such as a card/badge being swiped, a password/PIN being entered, a face/retina being scanned, etc.

In some existing mobile-based access control systems, credentials are centrally managed. This means that even if multiple access control mobile devices share some credentials, all access control mobile devices need to be synchronized with the central management system. This centralized approach can lead to challenges, particularly when having a centralized server is not viable. Existing centralized and offline synchronization solutions do not guarantee data availability. For applications such as mustering or checkpoints, if a centralized server is not feasible, the lack of guaranteed data availability can pose significant challenges.

In contrast, the credential mesh network according to the present aspects allows similar access control mobile devices to work as a singular unit by securely sharing credentials among each other. This eliminates the need for uninterrupted availability of a central service, and the access control mobile devices can synchronize with each other even when a centralized management system/service is offline. The decentralized credential management according to the present aspects ensures that access control mobile devices can form a mesh network and securely share credentials and operate as a cohesive unit. In an aspect, multiple access control mobile devices register and self-discover with a mesh management service, which groups them into a credential mesh network. The access control mobile devices then automatically identify each other through a handshake and determine the best session for data exchange. Some present aspects support a dynamic credential catalog. During initial data exchange, multiple access control mobile devices share a catalog of available clearances/credentials, and the credentials are downloaded only upon request or upon an access credential activity which may be an activity that elicits/requests confirmation of access credentials of an entity for access to an area/asset, such as a card/badge being swiped, a password/PIN being entered, a face/retina being scanned, etc. Some present aspects support real-time updating of the credential catalog, and the access control mobile devices dynamically update the list of available credentials based on change triggers.

Turning now to the figures, example aspects are depicted with reference to one or more components described herein, where components in dashed lines may be optional.

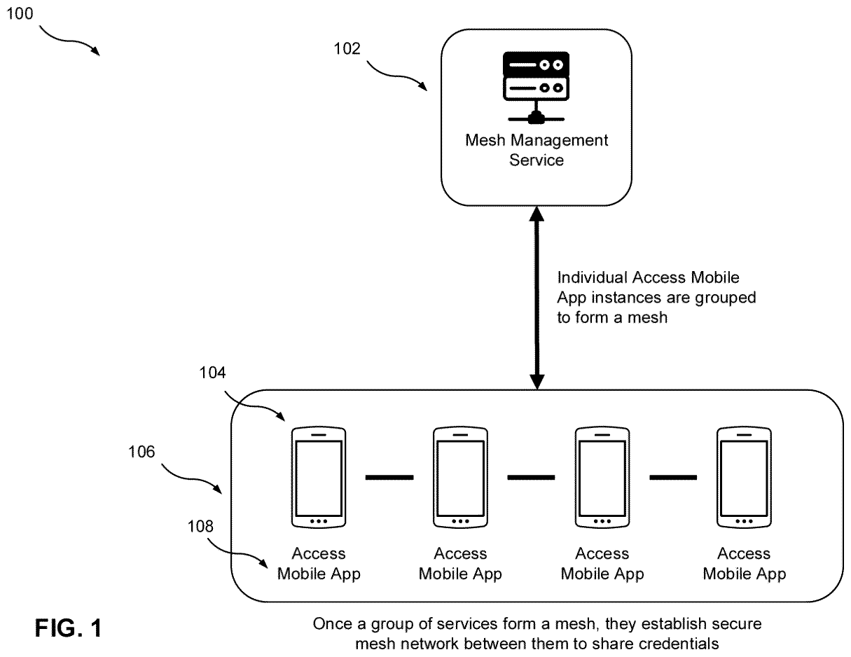

Referring to FIG. 1, in one non-limiting example aspect, an access control system 100 includes a mesh management service 102 configured for registering and grouping access control mobile devices 104 into a credential mesh network 106. The mesh management service 102 ensures that the access control mobile devices 104 can identify each other and manage sessions for data exchange. In an aspect, for example, each access control mobile device 104 runs an access control mobile app instance 108, and the mesh management service 102 groups multiple access control mobile app instances 108 to form the credential mesh network 106.

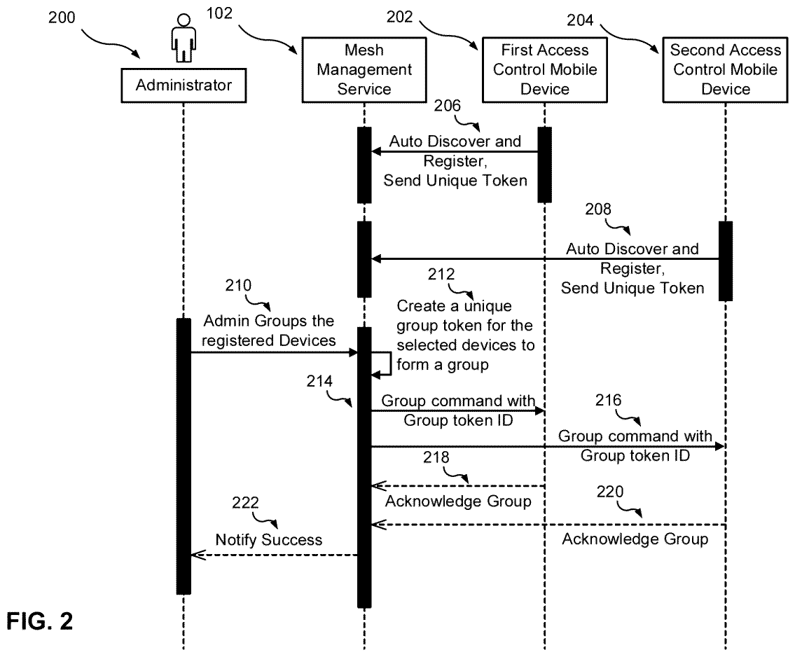

Referring to FIG. 2, in one non-limiting example aspect, at 206 and 208 each one of a first access control mobile device 202 and a second access control mobile device 204 auto discovers and registers with the mesh management service 102 and sends a respective unique device identifier (ID) token to the mesh management service 102. At 210 an administrator 200 may then group the registered access control mobile devices 202, 204 together into a credential mesh network, which causes the mesh management service 102 to create a unique group ID token for the registered access control mobile devices 202, 204 to form a credential group at 212. The mesh management service 102 then sends a group command and the unique group ID token to each one of the registered access control mobile devices 202, 204 at 214 and 216. In some aspects, each one of the registered access control mobile devices 202, 204 may then acknowledge the group to the mesh management service 102 at 218 and 220, which may then provide a success notification to the administrator 200 at 222. By using unique device ID tokens in forming a credential mesh network, only authorized devices can join the credential mesh network and access the shared credentials.

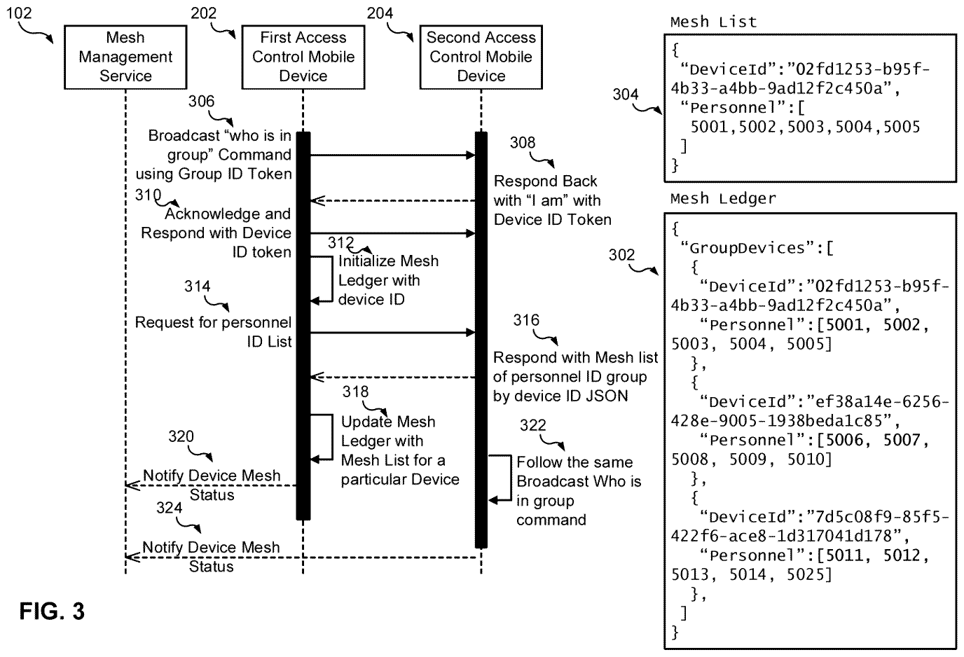

After the credential group comprising the registered access control mobile devices 202, 204 is formed, the registered access control mobile devices 202, 204 authenticate each other and exchange a catalog of available credentials during the initial handshake. For example, referring to FIG. 3, in one non-limiting example aspect, the registered access control mobile devices 202, 204 perform an automatic handshake to identify each other. Specifically, for example, at 306 the first access control mobile device 202 may broadcast a “who is in group” command using the group ID token, and at 308 the second access control mobile device 204 responds back with an “I am” message and its device ID token. At 310 the first access control mobile device 202 acknowledges and responds by sending its own device ID token to the second access control mobile device 204.

At 312 the first access control mobile device 202 initializes a mesh ledger 302 with the device ID tokens, and at 314 sends a request to the second access control mobile device 204 for personnel ID list, where each personnel ID is unique across the access control system 100. At 316 the second access control mobile device 204 responds with its mesh list 304 of personnel ID list, e.g., by sending a JavaScript Object Notation (JSON) message including its device ID. Upon receipt, at 318 the first access control mobile device 202 updates the mesh ledger 302 for the second access control mobile device 204, and may also notify the mesh management service 102 of the device mesh status at 320. At 322 the second access control mobile device 204 may follow with a similar broadcast of “who is in group” command, and may also notify the mesh management service 102 of the device mesh status at 324.

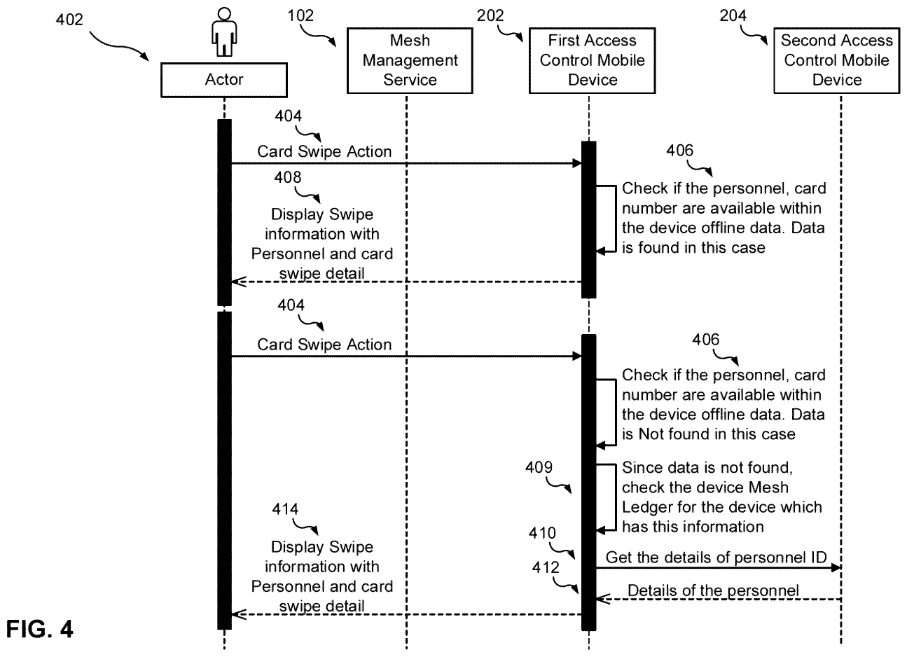

After the handshake, the registered access control mobile devices 202, 204 update the credential catalog based on change triggers. For example, referring to FIG. 4, at 404 when an actor 402 performs an access credential activity such as a card swipe action on the first access control mobile device 202, at 406 the first access control mobile device 202 checks whether the personnel information associated with the card number is available within the offline data of the first access control mobile device 202. It should be noted that the card swipe action described in this aspect is only a non-limiting example of an access credential activity which may be any activity that elicits/requests confirmation of access credentials of an entity for access to an area/asset, such as a card/badge being swiped, a password/PIN being entered, a face/retina being scanned, etc.

If the first access control mobile device 202 finds the data, at 408 the first access control mobile device 202 displays the corresponding swipe information with personnel and card swipe details. However, if the first access control mobile device 202 does not find the data, at 409 the first access control mobile device 202 checks the device mesh ledger for the device which has this information.

For example, if the device mesh ledger indicates that the second access control mobile device 204 has the required information, at 410 the first access control mobile device 202 sends a message to the second access control mobile device 204 to get the details associated with the personnel ID, and at 412 the second access control mobile device 204 may respond with the details of the corresponding personnel. At 414 the first access control mobile device 202 may then display the corresponding swipe information with personnel ID and card swipe details.

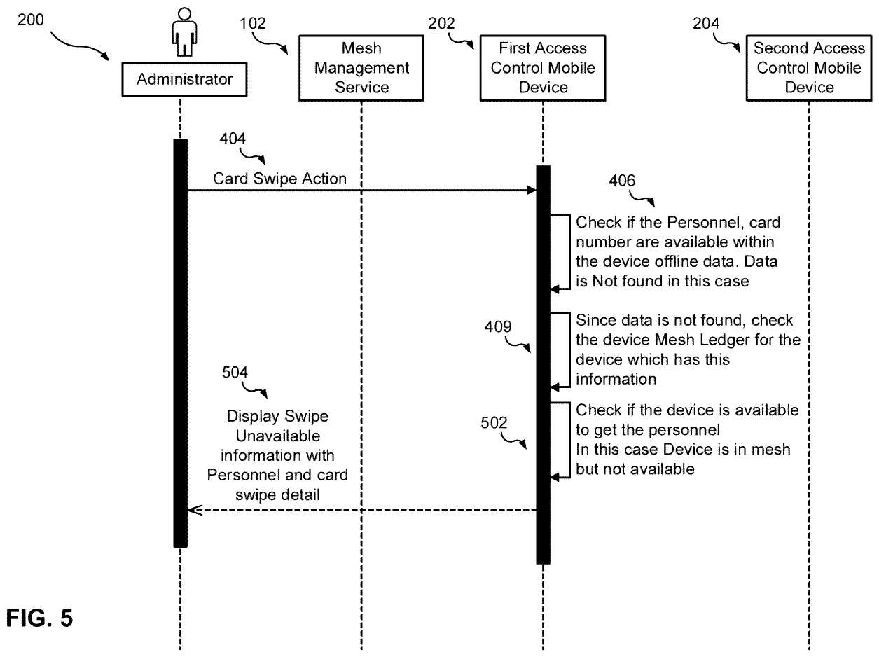

However, referring to FIG. 5, in some aspects, at 502 the first access control mobile device 202 may determine that the second access control mobile device 204 is not available to respond to the request of the first access control mobile device 202 for the details associated with the personnel ID. In this case, at 504 the first access control mobile device 202 may display that the swipe information associated with personnel ID is unavailable.

For example, the functionality in FIGS. 2-5 may be applicable in a mustering scenario to validate a group of people grouped into a specific area such as a main floor. In one non-limiting example aspect of mustering, card swipes on an access control mobile device are checked against a group list which has been downloaded to the access control mobile device when the access control mobile device is configured. Additionally, during configuration, an area may be mapped as a safe zone. When a person performs a successful card swipe on the access control mobile device, the person is allowed to move from the main floor to the area that is configured as a safe zone.

In some aspects, various data exchanges between the registered access control mobile devices 202, 204 are encrypted. Accordingly, the present aspects provide enhanced security via implementing secure data exchange and authentication mechanisms that protect against unauthorized access. The present aspects further provide increased availability, as the credential mesh network ensures data availability even when a centralized management system is offline. Additionally, the present aspects are readily scalable as more devices join a mesh network. Further, in cases where centralized servers are not viable, the present aspects provide flexibility and are suitable for scenarios such as mustering and checkpoints.

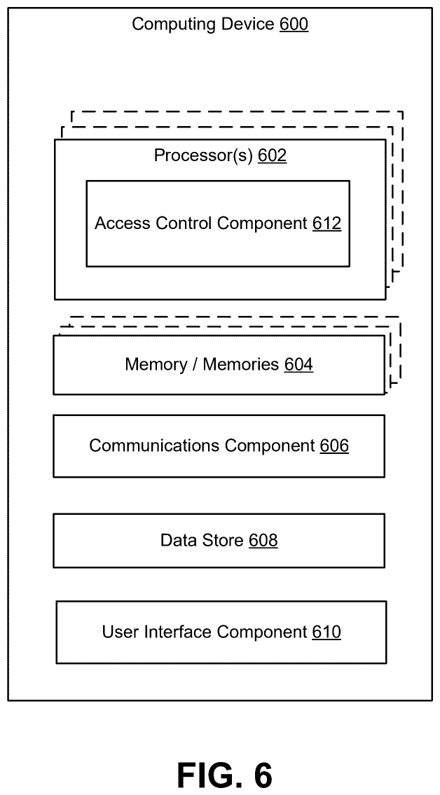

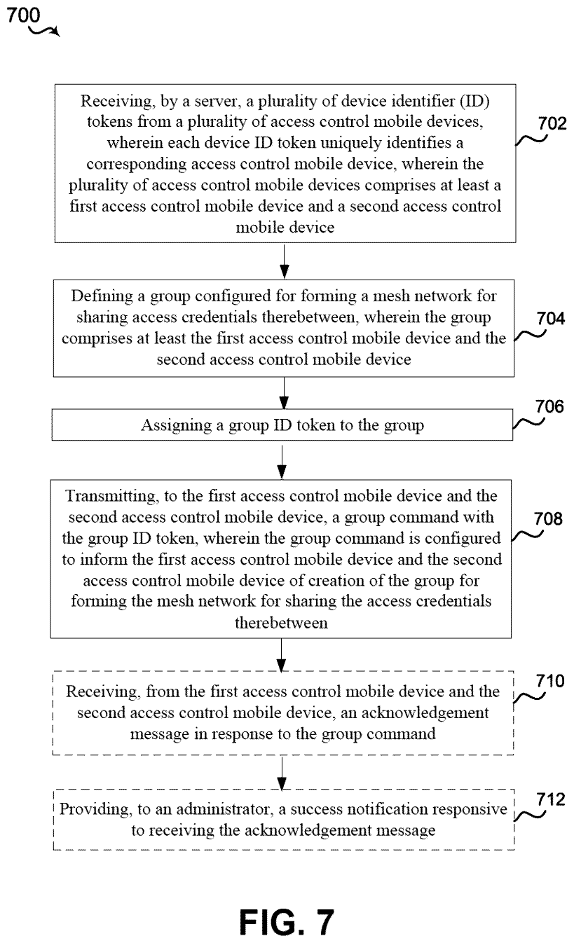

Referring to FIG. 6, an example block diagram provides details of computing components in a computing device 600 that may implement all or a portion of an access control mobile device, a mesh management service, or any other component described with reference to FIGS. 1-5 above or with reference to FIGS. 7-9 below. The computing device 600 includes one or more processors 602 which, individually, as a subgroup, or in combination, may be configured to execute or implement software, hardware, and/or firmware modules that perform any access control functionality described above with reference to FIGS. 1-5 above or with reference to FIGS. 7-9 below.

As used herein, a processor, at least one processor, and/or one or more processors, individually, as a subgroup, or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

The one or more processors 602 may be a micro-controller and/or may include a single or multiple set of processors or multi-core processors. Moreover, the one or more processors 602 may be implemented as an integrated processing system and/or a distributed processing system.

The computing device 600 may further include one or more memories 604, such as for storing local versions of applications being executed by the one or more processors 602, related instructions, parameters, etc. The one or more memories 604 may include a type of memory usable by a computer, such as random access memory (RAM), read only memory (ROM), tapes, magnetic discs, optical discs, volatile memory, non-volatile memory, and any combination thereof. Additionally, the one or more processors 602 and the one or more memories 604 may include and execute an operating system executing on the one or more processors 602, individually, as a subgroup, or in combination, one or more applications, display drivers, etc., and/or other components of the computing device 600.

As used herein, a memory, at least one memory, and/or one or more memories, individually, as a subgroup, or in combination, configured to store or having stored thereon instructions executable by one or more processors for performing a plurality of actions is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually, as a subgroup, or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, In combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

Further, the computing device 600 may include a communications component 606 that provides for establishing and maintaining communications with one or more other devices, parties, entities, etc., utilizing hardware, software, and services. The communications component 606 may carry communications between components on the computing device 600, as well as between the computing device 600 and external devices, such as devices located across a communications network and/or devices serially or locally connected to the computing device 600. For example, the communications component 606 may include one or more buses, and may further include transmit chain components and receive chain components associated with a wireless or wired transmitter and receiver, respectively, operable for interfacing with external devices.

Additionally, the computing device 600 may include a data store 608, which can be any suitable combination of hardware and/or software, that provides for mass storage of information, databases, and programs. For example, the data store 608 may be or may include a data repository for applications and/or related parameters not currently being executed by the one or more processors 602, individually, as a subgroup, or in combination. In addition, the data store 608 may be a data repository for an operating system, application, display driver, etc., executing on the one or more processors 602, individually, as a subgroup, or in combination, and/or one or more other components of the computing device 600.

The computing device 600 may also include a user interface component 610 operable to receive inputs from a user of the computing device 600 and further operable to generate outputs for presentation to the user (e.g., via a display interface to a display device). The user interface component 610 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 610 may include one or more output devices, including but not limited to a display interface, a speaker, a haptic feedback mechanism, a printer, any other mechanism capable of presenting an output to a user, or any combination thereof.

Referring to FIGS. 7-9, in operation for access control functionality, computing device 600 may implement at least a portion of one or more components in FIGS. 1-6 above, such as all or at least a portion of an access control mobile device, a mesh management service, or any other component configured for access control functionality. In this case, the computing device 600 may perform any one or any combination of methods 7-9 such as via execution of an access control component 612 by one or more processors 602 individually, as a subgroup, or in combination, and/or one or more memories 604 individually, as a subgroup, or in combination. Specifically, computing device 600 may be configured to perform any one or any combination of methods 7-9 for performing an aspect of access control functionality, as described herein.

Referring to FIG. 7, at 702 the method 700 includes receiving, by a server, a plurality of device identifier (ID) tokens from a plurality of access control mobile devices, wherein each device ID token uniquely identifies a corresponding access control mobile device, wherein the plurality of access control mobile devices comprises at least a first access control mobile device and a second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for receiving, by a server, a plurality of device identifier (ID) tokens from a plurality of access control mobile devices, wherein each device ID token uniquely identifies a corresponding access control mobile device, wherein the plurality of access control mobile devices comprises at least a first access control mobile device and a second access control mobile device.

For example, the mesh management service 102 may receive device ID tokens of the first access control mobile device 202 and the second access control mobile device 204 from them, where each device ID token uniquely identifies a corresponding access control mobile device.

At 704 the method 700 includes defining a group configured for forming a mesh network for sharing access credentials therebetween, wherein the group comprises at least the first access control mobile device and the second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for defining a group configured for forming a mesh network for sharing access credentials therebetween, wherein the group comprises at least the first access control mobile device and the second access control mobile device.

For example, the mesh management service 102 may define a group configured for forming a mesh network for sharing access credentials therebetween, where the group comprises at least the first access control mobile device 202 and the second access control mobile device 204.

At 706 the method 700 includes assigning a group ID token to the group. For example, in an aspect, computing device 600, one or more processors 602 individually, as a subgroup, or in combination, one or more memories 604 individually, as a subgroup, or in combination, and/or access control component 612 may be configured to or may comprise means for assigning a group ID token to the group.

For example, the mesh management service 102 may assign a group ID token to the group that includes at least the first access control mobile device 202 and the second access control mobile device 204.

At 708 the method 700 includes transmitting, to the first access control mobile device and the second access control mobile device, a group command with the group ID token, wherein the group command is configured to inform the first access control mobile device and the second access control mobile device of creation of the group for forming the mesh network for sharing the access credentials therebetween. For example, in an aspect, computing device 600, one or more processors 602 individually, as a subgroup, or in combination, one or more memories 604 individually, as a subgroup, or in combination, and/or access control component 612 may be configured to or may comprise means for transmitting, to the first access control mobile device and the second access control mobile device, a group command with the group ID token, wherein the group command is configured to inform the first access control mobile device and the second access control mobile device of creation of the group for forming the mesh network for sharing the access credentials therebetween.

For example, the mesh management service 102 may transmit, to the first access control mobile device 202 and the second access control mobile device 204, a group command with the group ID token, wherein the group command is configured to inform the first access control mobile device 202 and the second access control mobile device 204 of creation of the group for forming the mesh network for sharing the access credentials therebetween.

Optionally, at 710 the method 700 may further include receiving, from the first access control mobile device and the second access control mobile device, an acknowledgement message in response to the group command. For example, in an aspect, computing device 600, one or more processors 602 individually, as a subgroup, or in combination, one or more memories 604 individually, as a subgroup, or in combination, and/or access control component 612 may be configured to or may comprise means for receiving, from the first access control mobile device and the second access control mobile device, an acknowledgement message in response to the group command.

For example, the mesh management service 102 may receive, from the first access control mobile device 202 and the second access control mobile device 204, an acknowledgement message in response to the group command.

Optionally, at 712 the method 700 may further include providing, to an administrator, a success notification responsive to receiving the acknowledgement message. For example, in an aspect, computing device 600, one or more processors 602 individually, as a subgroup, or in combination, one or more memories 604 individually, as a subgroup, or in combination, and/or access control component 612 may be configured to or may comprise means for providing, to an administrator, a success notification responsive to receiving the acknowledgement message.

For example, the mesh management service 102 may provide, to an administrator 200, a success notification responsive to receiving the acknowledgement message.

In some optional implementations, the first access control mobile device 202 and the second access control mobile device 204 are configured to autodiscover the mesh management service 102 and register with the mesh management service 102.

In some optional implementations, the first access control mobile device 202 is uniquely identified by a first device ID token, and the second access control mobile device 204 is uniquely identified by a second device ID token.

In some optional implementations, the group command includes the first device ID token and the second device ID token.

In some optional implementation, defining the group is based on information received by the mesh management service 102 from an administrator 200.

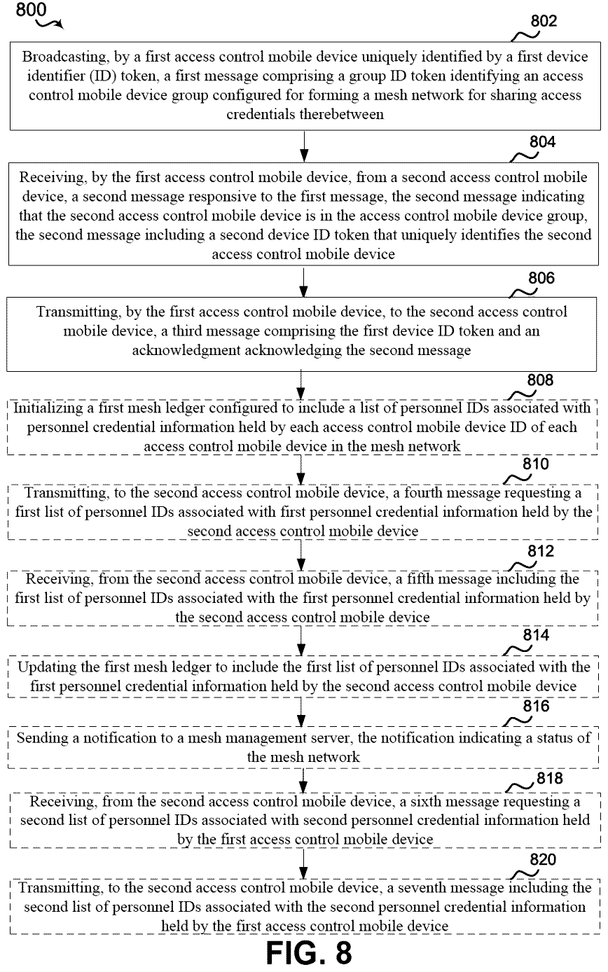

Referring to FIG. 8, at 802 the method 800 includes broadcasting, by a first access control mobile device uniquely identified by a first device identifier (ID) token, a first message comprising a group ID token identifying an access control mobile device group configured for forming a mesh network for sharing access credentials therebetween. For example, in an aspect, computing device 600, one or more processors 602 individually, as a subgroup, or in combination, one or more memories 604 individually, as a subgroup, or in combination, and/or access control component 612 may be configured to or may comprise means for broadcasting, by a first access control mobile device uniquely identified by a first device identifier (ID) token, a first message comprising a group ID token identifying an access control mobile device group configured for forming a mesh network for sharing access credentials therebetween.

For example, the first access control mobile device 202 uniquely identified by a first device identifier (ID) token may broadcast a first message comprising a group ID token identifying an access control mobile device group configured for forming a mesh network for sharing access credentials therebetween.

At 804 the method 800 includes receiving, by the first access control mobile device, from a second access control mobile device, a second message responsive to the first message, the second message indicating that the second access control mobile device is in the access control mobile device group, the second message including a second device ID token that uniquely identifies the second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for receiving, by the first access control mobile device, from a second access control mobile device, a second message responsive to the first message, the second message indicating that the second access control mobile device is in the access control mobile device group, the second message including a second device ID token that uniquely identifies the second access control mobile device.

For example, the first access control mobile device 202 may receive, from the second access control mobile device 204, a second message responsive to the first message, the second message indicating that the second access control mobile device 204 is in the access control mobile device group, the second message including a second device ID token that uniquely identifies the second access control mobile device 204.

At 806 the method 800 includes transmitting, by the first access control mobile device, to the second access control mobile device, a third message comprising the first device ID token and an acknowledgment acknowledging the second message. For example, in an aspect, computing device 600, one or more processors 602 individually, as a subgroup, or in combination, one or more memories 604 individually, as a subgroup, or in combination, and/or access control component 612 may be configured to or may comprise means for transmitting, by the first access control mobile device, to the second access control mobile device, a third message comprising the first device ID token and an acknowledgment acknowledging the second message.

For example, the first access control mobile device 202 may transmit, to the second access control mobile device 204, a third message comprising the first device ID token and an acknowledgment acknowledging the second message.

Optionally, at 808 the method 800 may further include initializing a first mesh ledger configured to include a list of personnel IDs associated with personnel credential information held by each access control mobile device ID of each access control mobile device in the mesh network. For example, in an aspect, computing device 600, one or more processors 602 individually, as a subgroup, or in combination, one or more memories 604 individually, as a subgroup, or in combination, and/or access control component 612 may be configured to or may comprise means for initializing a first mesh ledger configured to include a list of personnel IDs associated with personnel credential information held by each access control mobile device ID of each access control mobile device in the mesh network.

For example, the first access control mobile device 202 may initialize the mesh ledger 302 configured to include a list of personnel IDs associated with personnel credential information held by each access control mobile device ID of each access control mobile device in the mesh network.

Optionally, at 810 the method 800 may further include transmitting, to the second access control mobile device, a fourth message requesting a first list of personnel IDs associated with first personnel credential information held by the second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for transmitting, to the second access control mobile device, a fourth message requesting a first list of personnel IDs associated with first personnel credential information held by the second access control mobile device.

For example, the first access control mobile device 202 may transmit, to the second access control mobile device 204, a fourth message requesting the mesh list 304 of personnel IDs associated with first personnel credential information held by the second access control mobile device 204.

Optionally, at 812 the method 800 may further include receiving, from the second access control mobile device, a fifth message including the first list of personnel IDs associated with the first personnel credential information held by the second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for receiving, from the second access control mobile device, a fifth message including the first list of personnel IDs associated with the first personnel credential information held by the second access control mobile device.

For example, the first access control mobile device 202 may receive, from the second access control mobile device 204, a fifth message including the mesh list 304 of personnel IDs associated with the first personnel credential information held by the second access control mobile device 204.

Optionally, at 814 the method 800 may further include updating the first mesh ledger to include the first list of personnel IDs associated with the first personnel credential information held by the second access control mobile device. For example, in an aspect, computing device 600, one or more processors 602 individually, as a subgroup, or in combination, one or more memories 604 individually, as a subgroup, or in combination, and/or access control component 612 may be configured to or may comprise means for updating the first mesh ledger to include the first list of personnel IDs associated with the first personnel credential information held by the second access control mobile device.

For example, the first access control mobile device 202 may update the mesh ledger 302 to include the mesh list 304 of personnel IDs associated with the first personnel credential information held by the second access control mobile device 204.

Optionally, at 816 the method 800 may further include sending a notification to a mesh management server, the notification indicating a status of the mesh network. For example, in an aspect, computing device 600, one or more processors 602 individually, as a subgroup, or in combination, one or more memories 604 individually, as a subgroup, or in combination, and/or access control component 612 may be configured to or may comprise means for sending a notification to a mesh management server, the notification indicating a status of the mesh network.

For example, the first access control mobile device 202 may send a notification to a the mesh management service 102, the notification indicating a status of the mesh network.

Optionally, at 818 the method 800 may further include receiving, from the second access control mobile device, a sixth message requesting a second list of personnel IDs associated with second personnel credential information held by the first access control mobile device. For example, in an aspect, computing device 600, one or more processors 602 individually, as a subgroup, or in combination, one or more memories 604 individually, as a subgroup, or in combination, and/or access control component 612 may be configured to or may comprise means for receiving, from the second access control mobile device, a sixth message requesting a second list of personnel IDs associated with second personnel credential information held by the first access control mobile device.

For example, the first access control mobile device 202 may receive, from the second access control mobile device 204, a sixth message requesting a second list of personnel IDs associated with second personnel credential information held by the first access control mobile device 202.

Optionally, at 820 the method 800 may further include transmitting, to the second access control mobile device, a seventh message including the second list of personnel IDs associated with the second personnel credential information held by the first access control mobile device. For example, in an aspect, computing device 600, one or more processors 602 individually, as a subgroup, or in combination, one or more memories 604 individually, as a subgroup, or in combination, and/or access control component 612 may be configured to or may comprise means for transmitting, to the second access control mobile device, a seventh message including the second list of personnel IDs associated with the second personnel credential information held by the first access control mobile device.

For example, the first access control mobile device 202 may transmit, to the second access control mobile device 204, a seventh message including the second list of personnel IDs associated with the second personnel credential information held by the first access control mobile device 202.

In some optional implementations, the seventh message is configured to cause the second access control mobile device 204 to update a second mesh ledger to include the second list of personnel IDs associated with the second personnel credential information held by the first access control mobile device 202.

In some optional implementations, the seventh message is further configured to cause the second access control mobile device 204 to send a notification to the mesh management service 102, the notification indicating a status of the mesh network.

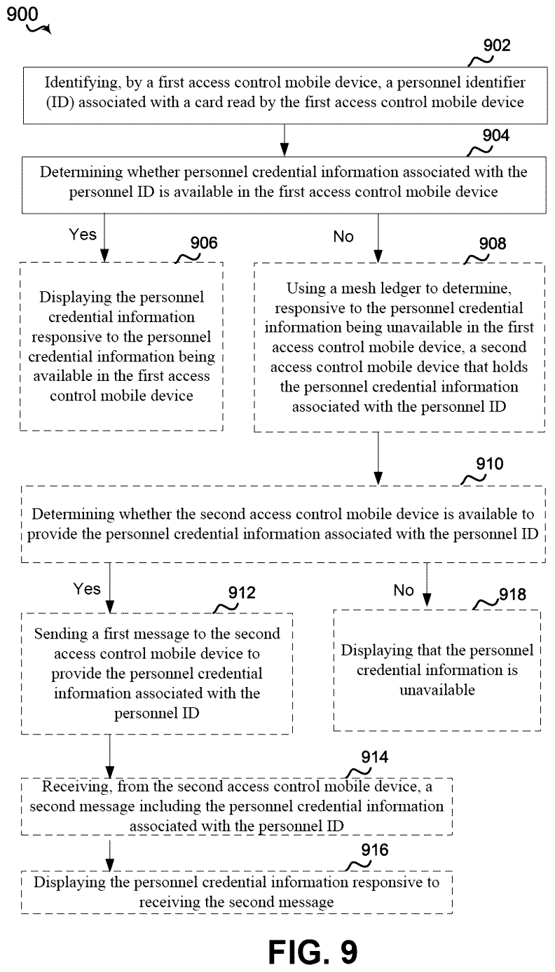

Referring to FIG. 9, at 902 the method 900 includes identifying, by a first access control mobile device, a personnel identifier (ID) associated with a card read by the first access control mobile device. For example, in an aspect, computing device 600, one or more processors 602 individually, as a subgroup, or in combination, one or more memories 604 individually, as a subgroup, or in combination, and/or access control component 612 may be configured to or may comprise means for identifying, by a first access control mobile device, a personnel identifier (ID) associated with a card read by the first access control mobile device.

For example, the first access control mobile device 202 may identify a personnel ID associated with a card read by the first access control mobile device 202.

At 904 the method 900 includes determining whether personnel credential information associated with the personnel ID is available in the first access control mobile device. For example, in an aspect, computing device 600, one or more processors 602 individually, as a subgroup, or in combination, one or more memories 604 individually, as a subgroup, or in combination, and/or access control component 612 may be configured to or may comprise means for determining whether personnel credential information associated with the personnel ID is available in the first access control mobile device.

For example, the first access control mobile device 202 may determine whether personnel credential information associated with the personnel ID is available in the first access control mobile device 202.

Optionally, at 906 the method 900 may further include displaying the personnel credential information responsive to the personnel credential information being available in the first access control mobile device. For example, in an aspect, computing device 600, one or more processors 602 individually, as a subgroup, or in combination, one or more memories 604 individually, as a subgroup, or in combination, and/or access control component 612 may be configured to or may comprise means for displaying the personnel credential information responsive to the personnel credential information being available in the first access control mobile device.

For example, the first access control mobile device 202 may display the personnel credential information responsive to the personnel credential information being available in the first access control mobile device 202.

Optionally, at 908 the method 900 may further include using a mesh ledger to determine, responsive to the personnel credential information being unavailable in the first access control mobile device, a second access control mobile device that holds the personnel credential information associated with the personnel ID. For example, in an aspect, computing device 600, one or more processors 602 individually, as a subgroup, or in combination, one or more memories 604 individually, as a subgroup, or in combination, and/or access control component 612 may be configured to or may comprise means for using a mesh ledger to determine, responsive to the personnel credential information being unavailable in the first access control mobile device, a second access control mobile device that holds the personnel credential information associated with the personnel ID.

For example, the first access control mobile device 202 may use the mesh ledger 302 to determine, responsive to the personnel credential information being unavailable in the first access control mobile device 202, that the second access control mobile device 204 holds the personnel credential information associated with the personnel ID.

Optionally, at 910 the method 900 may further include determining whether the second access control mobile device is available to provide the personnel credential information associated with the personnel ID. For example, in an aspect, computing device 600, one or more processors 602 individually, as a subgroup, or in combination, one or more memories 604 individually, as a subgroup, or in combination, and/or access control component 612 may be configured to or may comprise means for determining whether the second access control mobile device is available to provide the personnel credential information associated with the personnel ID.

For example, the first access control mobile device 202 may determine whether the second access control mobile device 204 is available to provide the personnel credential information associated with the personnel ID.

Optionally, responsive to the second access control mobile device being available, at 912 the method 900 may further include sending a first message to the second access control mobile device to provide the personnel credential information associated with the personnel ID. For example, in an aspect, responsive to the second access control mobile device being available, computing device 600, one or more processors 602 individually, as a subgroup, or in combination, one or more memories 604 individually, as a subgroup, or in combination, and/or access control component 612 may be configured to or may comprise means for sending a first message to the second access control mobile device to provide the personnel credential information associated with the personnel ID.

For example, responsive to the second access control mobile device 204 being available, the first access control mobile device 202 may send a first message to the second access control mobile device 204 to provide the personnel credential information associated with the personnel ID.

Optionally, at 914 the method 900 may further include receiving, from the second access control mobile device, a second message including the personnel credential information associated with the personnel ID. For example, in an aspect, computing device 600, one or more processors 602 individually, as a subgroup, or in combination, one or more memories 604 individually, as a subgroup, or in combination, and/or access control component 612 may be configured to or may comprise means for receiving, from the second access control mobile device, a second message including the personnel credential information associated with the personnel ID.

For example, the first access control mobile device 202 may receive, from the second access control mobile device 204, a second message including the personnel credential information associated with the personnel ID.

Optionally, at 916 the method 900 may further include displaying the personnel credential information responsive to receiving the second message. For example, in an aspect, computing device 600, one or more processors 602 individually, as a subgroup, or in combination, one or more memories 604 individually, as a subgroup, or in combination, and/or access control component 612 may be configured to or may comprise means for displaying the personnel credential information responsive to receiving the second message.

For example, the first access control mobile device 202 may display the personnel credential information responsive to receiving the second message.

Optionally, responsive to the second access control mobile device being unavailable, at 918 the method 900 may further include displaying that the personnel credential information is unavailable. For example, in an aspect, responsive to the second access control mobile device being unavailable, computing device 600, one or more processors 602 individually, as a subgroup, or in combination, one or more memories 604 individually, as a subgroup, or in combination, and/or access control component 612 may be configured to or may comprise means for displaying that the personnel credential information is unavailable.

For example, responsive to the second access control mobile device 204 being unavailable, the first access control mobile device 202 may display that the personnel credential information is unavailable.

In some optional implementation, the mesh ledger 302 includes a list of personnel IDs whose associated personnel credential information are held by each access control mobile device ID of each access control mobile device in a mesh network comprising the first access control mobile device 202 and the second access control mobile device 204.

Another example aspect includes an apparatus comprising one or more memories storing instructions, and one or more processors coupled with the one or more memories. The one or more processors, individually, as a subgroup, or in combination, are configured to execute the instructions to perform any access control functionality described herein.

Another example aspect includes an apparatus comprising means for perform any access control functionality described herein.

Another example aspect includes one or more computer-readable media having instructions stored thereon, wherein the instructions are executable by one or more processors, individually, as a subgroup, or in combination, to perform any access control functionality described herein.

Some further aspects are provided below in the form of clauses.
1. A method comprising:
receiving, by a server, a plurality of device identifier (ID) tokens from a plurality of access control mobile devices, wherein each device ID token uniquely identifies a corresponding access control mobile device, wherein the plurality of access control mobile devices comprises at least a first access control mobile device and a second access control mobile device;
defining a group configured for forming a mesh network for sharing access credentials therebetween, wherein the group comprises at least the first access control mobile device and the second access control mobile device;
assigning a group ID token to the group; and
transmitting, to the first access control mobile device and the second access control mobile device, a group command with the group ID token, wherein the group command is configured to inform the first access control mobile device and the second access control mobile device of creation of the group for forming the mesh network for sharing the access credentials therebetween.
2. The method of clause 1, wherein the first access control mobile device and the second access control mobile device are configured to autodiscover the server and register with the server.
3. The method of clause 1 or 2, wherein the first access control mobile device is uniquely identified by a first device ID token, wherein the second access control mobile device is uniquely identified by a second device ID token.
4. The method of clause 3, wherein the group command includes the first device ID token and the second device ID token.
5. The method of any one of the above clauses, wherein defining the group is based on information received by the server from an administrator.
6. The method of any one of the above clauses, further comprising receiving, from the first access control mobile device and the second access control mobile device, an acknowledgement message in response to the group command.
7. The method of clause 6, further comprising providing, to an administrator, a success notification responsive to receiving the acknowledgement message.
8. A method comprising:
broadcasting, by a first access control mobile device uniquely identified by a first device identifier (ID) token, a first message comprising a group ID token identifying an access control mobile device group configured for forming a mesh network for sharing access credentials therebetween;
receiving, by the first access control mobile device, from a second access control mobile device, a second message responsive to the first message, the second message indicating that the second access control mobile device is in the access control mobile device group, the second message including a second device ID token that uniquely identifies the second access control mobile device; and
transmitting, by the first access control mobile device, to the second access control mobile device, a third message comprising the first device ID token and an acknowledgment acknowledging the second message.
9. The method of clause 8, further comprising initializing a first mesh ledger configured to include a list of personnel IDs associated with personnel credential information held by each access control mobile device ID of each access control mobile device in the mesh network.
10. The method of clause 9, further comprising:
transmitting, to the second access control mobile device, a fourth message requesting a first list of personnel IDs associated with first personnel credential information held by the second access control mobile device;
receiving, from the second access control mobile device, a fifth message including the first list of personnel IDs associated with the first personnel credential information held by the second access control mobile device; and
updating the first mesh ledger to include the first list of personnel IDs associated with the first personnel credential information held by the second access control mobile device.
11. The method of clause 10, further comprising sending a notification to a mesh management server, the notification indicating a status of the mesh network.
12. The method of clause 10 or 11, further comprising:
receiving, from the second access control mobile device, a sixth message requesting a second list of personnel IDs associated with second personnel credential information held by the first access control mobile device; and
transmitting, to the second access control mobile device, a seventh message including the second list of personnel IDs associated with the second personnel credential information held by the first access control mobile device.
13. The method of clause 12, wherein the seventh message is configured to cause the second access control mobile device to update a second mesh ledger to include the second list of personnel IDs associated with the second personnel credential information held by the first access control mobile device.
14. The method of clause 12 or 13, wherein the seventh message is further configured to cause the second access control mobile device to send a notification to a mesh management server, the notification indicating a status of the mesh network.
15. A method comprising:
identifying, by a first access control mobile device, a personnel identifier (ID) associated with a card read by the first access control mobile device;
determining whether personnel credential information associated with the personnel ID is available in the first access control mobile device; and
displaying the personnel credential information responsive to the personnel credential information being available in the first access control mobile device.
16. The method of clause 15, further comprising using a mesh ledger to determine, responsive to the personnel credential information being unavailable in the first access control mobile device, a second access control mobile device that holds the personnel credential information associated with the personnel ID.
17. The method of clause 16, wherein the mesh ledger includes a list of personnel IDs whose associated personnel credential information are held by each access control mobile device ID of each access control mobile device in a mesh network comprising the first access control mobile device and the second access control mobile device.
18. The method of clause 16 or 17, further comprising determining whether the second access control mobile device is available to provide the personnel credential information associated with the personnel ID.
19. The method of clause 18, further comprising, responsive to the second access control mobile device being available:
sending a first message to the second access control mobile device to provide the personnel credential information associated with the personnel ID;
receiving, from the second access control mobile device, a second message including the personnel credential information associated with the personnel ID; and
displaying the personnel credential information responsive to receiving the second message.
20. The method of clause 18, further comprising, responsive to the second access control mobile device being unavailable, displaying that the personnel credential information is unavailable.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
receiving, by a server, a plurality of device identifier (ID) tokens from a plurality of access control mobile devices, wherein each device ID token uniquely identifies a corresponding access control mobile device, wherein the plurality of access control mobile devices comprises at least a first access control mobile device and a second access control mobile device;
defining a group configured for forming a mesh network for sharing access credentials therebetween, wherein the group comprises at least the first access control mobile device and the second access control mobile device;
assigning a group ID token to the group; and
transmitting, to the first access control mobile device and the second access control mobile device, a group command with the group ID token, wherein the group command is configured to inform the first access control mobile device and the second access control mobile device of creation of the group for forming the mesh network for sharing the access credentials therebetween.

2. The method of claim 1, wherein the first access control mobile device and the second access control mobile device are configured to autodiscover the server and register with the server.

3. The method of claim 1, wherein the first access control mobile device is uniquely identified by a first device ID token, wherein the second access control mobile device is uniquely identified by a second device ID token.

4. The method of claim 3, wherein the group command includes the first device ID token and the second device ID token.

5. The method of claim 1, wherein defining the group is based on information received by the server from an administrator.

6. The method of claim 1, further comprising receiving, from the first access control mobile device and the second access control mobile device, an acknowledgement message in response to the group command.

7. The method of claim 6, further comprising providing, to an administrator, a success notification responsive to receiving the acknowledgement message.

8. A method comprising:
broadcasting, by a first access control mobile device uniquely identified by a first device identifier (ID) token, a first message comprising a group ID token identifying an access control mobile device group configured for forming a mesh network for sharing access credentials therebetween;
receiving, by the first access control mobile device, from a second access control mobile device, a second message responsive to the first message, the second message indicating that the second access control mobile device is in the access control mobile device group, the second message including a second device ID token that uniquely identifies the second access control mobile device; and
transmitting, by the first access control mobile device, to the second access control mobile device, a third message comprising the first device ID token and an acknowledgment acknowledging the second message.

9. The method of claim 8, further comprising initializing a first mesh ledger configured to include a list of personnel IDs associated with personnel credential information held by each access control mobile device ID of each access control mobile device in the mesh network.

10. The method of claim 9, further comprising:
transmitting, to the second access control mobile device, a fourth message requesting a first list of personnel IDs associated with first personnel credential information held by the second access control mobile device;
receiving, from the second access control mobile device, a fifth message including the first list of personnel IDs associated with the first personnel credential information held by the second access control mobile device; and
updating the first mesh ledger to include the first list of personnel IDs associated with the first personnel credential information held by the second access control mobile device.

11. The method of claim 10, further comprising sending a notification to a mesh management server, the notification indicating a status of the mesh network.

12. The method of claim 10, further comprising:
receiving, from the second access control mobile device, a sixth message requesting a second list of personnel IDs associated with second personnel credential information held by the first access control mobile device; and
transmitting, to the second access control mobile device, a seventh message including the second list of personnel IDs associated with the second personnel credential information held by the first access control mobile device.

13. The method of claim 12, wherein the seventh message is configured to cause the second access control mobile device to update a second mesh ledger to include the second list of personnel IDs associated with the second personnel credential information held by the first access control mobile device.

14. The method of claim 12, wherein the seventh message is further configured to cause the second access control mobile device to send a notification to a mesh management server, the notification indicating a status of the mesh network.

15. A method comprising:
identifying, by a first access control mobile device, a personnel identifier (ID) associated with a card read by the first access control mobile device;
determining whether personnel credential information associated with the personnel ID is available in the first access control mobile device; and
displaying the personnel credential information responsive to the personnel credential information being available in the first access control mobile device.

16. The method of claim 15, further comprising using a mesh ledger to determine, responsive to the personnel credential information being unavailable in the first access control mobile device, a second access control mobile device that holds the personnel credential information associated with the personnel ID.

17. The method of claim 16, wherein the mesh ledger includes a list of personnel IDs whose associated personnel credential information are held by each access control mobile device ID of each access control mobile device in a mesh network comprising the first access control mobile device and the second access control mobile device.

18. The method of claim 16, further comprising determining whether the second access control mobile device is available to provide the personnel credential information associated with the personnel ID.

19. The method of claim 18, further comprising, responsive to the second access control mobile device being available:
sending a first message to the second access control mobile device to provide the personnel credential information associated with the personnel ID;
receiving, from the second access control mobile device, a second message including the personnel credential information associated with the personnel ID; and
displaying the personnel credential information responsive to receiving the second message.

20. The method of claim 18, further comprising, responsive to the second access control mobile device being unavailable, displaying that the personnel credential information is unavailable.
